(19) United States
(12) Patent Application Publication
(10) Pub. No.: US 2013/0114787 A1
(43) Pub. Date: May 9, 2013

(54) PORTABLE X-RAY SYSTEM AND REMOTE CONTROL

(71) Applicant: Robert BROWN, Nampa, ID (US)

(72) Inventor: Robert BROWN, Nampa, ID (US)

(73) Assignee: WMDTech Services LLC

(21) Appl. No.: 13/464,780

(22) Filed: May 4, 2012

Related U.S. Application Data
(60) Provisional application No. 61/482,532, filed on May 4, 2011.
(60) Provisional application No. 61/591,482, filed on Jan. 27, 2012.

(51) Int. Cl. G01N 23/04

(52) U.S. Cl. 378/57

(57) ABSTRACT

Disclosed is a system for X-Ray examination of a target, which includes uprange controller means, a scintillator for sensing actually radiation sent, and a dosimeter for placing behind said target, for determining proper exposure of an image plate.

### PRIORITY/CROSS-REFERENCE TO RELATED APPLICATIONS

This application claims the benefit of U.S. Provisional Application No. 61/482,532, filed May 04, 2011, and U.S. Provisional Application No. 61/591,482, filed Jan. 27, 2012, the disclosure of which is incorporated by reference.

### TECHNICAL FIELD

The disclosed technology relates to controllers for portable X-Ray devices and more particularly to a wireless controller for controlling portable X-Rays and other related technologies.

### BACKGROUND

Portable X-Rays are used by bomb squads to analyze a package which may be suspected of being a bomb or having harmful substances. The current procedure is to have a bomb technician in a bomb suit place a portable X-Ray generator next to the suspected bomb, which is called a target. On the opposite side of the target an image plate is positioned which records an image of the contents of the target when the target is irradiated with radiation from the X-Ray generator. The preferred X-Ray generator is a pulse type generator rather than a continuous wave type X-Ray generator. The advantage of using pulses rather than a continuous wave type is that the bomb technician can select the number of pulses to be applied, and the radiation that the target is going to receive is thus easier to quantify. With a continuous wave type X-Ray, the bomb squad technician must activate the on switch and hold it until he thinks the required duration has been achieved. Then he would have to go back to the X-Ray generator and set it for more exposure if required. All the time he is operating the continuous X-Ray generator he would be in a bomb suit and his vision and hearing would be extremely impaired. In the case of a pulse type X-Ray, he could not hear the pulses as they were generated, and would have to wait until he thought they were finished with a cycle, but the pulse type generator is more easily quantified.

Current pulse type X-Ray generators have a maximum number of pulses they can deliver before they have to be given a rest period to cool down. Depending on the model and the manufacturer, that might be 99 pulses followed by a rest period of several minutes. If it was determined that the target needed to be irradiated with 495 pulses, this would require 5 trips to the X-Ray source in order to perform 5 cycles of 99 pulses each.

For safety reasons, the fewer times the technician has to be close to the target, the better. In order to minimize the radiation exposure to the bomb squad technician, either the distance from the source, the time exposed to the source, or the shielding from the source must be optimized. The shielding can be optimized by the X-Ray technician being behind a building, although this would make it impossible for him to see the source or the target. In one way not seeing the target is good, because in this industry the saying is that if you can see the target, the target can see you. The meaning of this is that if the target blows up, if you can see the target it is possible for the technician to be impacted by pieces of the target. In order to decrease exposure to the radiation it would greatly reduce the technician's exposure if he were further away from the source and the target and separated from the target by intervening material acting as shielding, such as walls or rocks.

The distance from the source and the target is somewhat restricted now because the technician might have to go to the target multiple times in order to reset the X-Ray source. With that requirement the technician would tend to position himself closer to the X-Ray source so that he wouldn't have to walk so far. This also exposes the bomb technician to being close to the target more often, which could explode at any time.

### SUMMARY OF THE DISCLOSURE

These problems are addressed by the disclosed portable X-Ray system and the control unit units of the present invention. The X-Ray and system uprange controller of the invention includes a portable X-Ray generator of the pulse type X-Ray source. The uprange controller device provides the ability to set the required number of pulses, to set the pulses per cycle, and to set the break time between cycles of pulses. With the uprange controller unit the technician would not have to approach the source or the target until all of the X-Ray work had been done. If the image plate and the X-Ray generator are mounted on uprange controllerled transport units, the entire operation could be done remotely.

Shown on the uprange controller is the pulse setting, showing how many pulses are to be delivered. Also shown on the uprange controller is a pulse counter, typically in a countdown format, which shows how many pulses have been delivered of the number that was assigned to be delivered. This read out is a measurement of actual pulses delivered, as sensed by a scintillator at the X-Ray generator.

The system can include repeaters which would allow the control unit to be further away from the X-Ray source and the target. With the use of repeaters, the technician can be behind protective obstacles such as the corners of buildings, concrete walls, and behind other terrain features in order to minimize radiation exposure and damage from the target if it explodes. With the standard wireless controller a 300 foot distance is the norm, and with repeaters up to 2 miles distant or more is possible. By the use of an XBee transceiver module 10 km is possible and that can be increased to as much as 80 km.

An important feature of the system is a sensor on the X-Ray generator which senses the actual radiation generated by the machine. Some machines report on the number of pulses that the generator thinks it has generated, but a false report can result in a report of multiple pulses being generated, when in reality no radiation was directed at the target. This is solved by a sensor, in one embodiment a scintillator, which senses actual radiation being sent, not just what the generator “thinks” it has sent. This ability to confirm the radiation being sent reduces the situation where the X-Ray film is developed, only to find that the X-Ray plate exposure has to be repeated because there was an error and no radiation was actually sent to the target.

To address this problem, the generator is fitted with a sensor, which communicates with the remote monitor to report on radiation that has been sensed leaving the generator. This sensor can be an X-Ray scintillator, or other sensors known in the industry. The X-Ray Scintillator is a component of the wireless X-Ray uprange controller that allows the uprange controller to monitor the transmission of X-Rays from whichever X-Ray source that is being used, such as one made by Golden Engineering. One version of an X-Ray scintillator utilizes a Cadmium Tungstate Crystal (although other technologies are also possible, such as Calcium Tungstate Film) that emits light when struck by X-Ray wavelength energy. In the case of using an X-Ray scintillator, the emitted light is monitored by a photo diode which can detect the wavelength of light emitted by those crystals, and is fast enough in function to be able to account for every individual pulse of X-Ray energy. Other sensors could report sensed X-Rays as electrical signals, or other known sensing technologies.

The X-Ray scintillator is a component of the Wireless X-Ray Uprange controller that allows the Controller to monitor the transmission of X-Rays from whichever Golden X-Ray Source that is being used.

The emitted light from the scintillator is monitored by a photo diode which can detect the wavelength of light emitted by those crystals, and is fast enough in function to be able to account for every individual pulse of X-Ray energy.

The output of the photo diode is sent to a microprocessor which counts each individual pulse, and tracks it against the number of pulses that were required by the “transmit order” created by the user of the Wire-Less X-Ray Controller.

During Very Low Pulse operations (between 1-3 pulses per “volley”), the Scintillator will be used as a fast-feedback loop to signal to the micro-processor when to turn off the X-Ray controller after each “volley” of pulses is emitted. For normal operations, the Scintillator will be used merely to count the number of pulses so that the wireless controller can shut down the Golden X-Ray Source at the end of each volley, and when the desired total pulse count is achieved.

Currently, the Scintillator Crystal are small, circular bits (approximately 5 mm in radius) and will sit on the far edge of the transmission cone of the Golden X-Ray Sources and do not affect the transmission onto the film.

The output of the photo diode is sent to a microprocessor which counts each individual pulse, and tracks it against the number of pulses that were required by the “transmit order” created by the user of the wireless X-Ray controller. During very low pulse operations (between 1-3 pulses per “volley”), the scintillator will be used as a fast-feedback loop to signal to the micro-processor when to turn off the X-Ray controller after each “volley” of pulses is emitted. For normal operations, the scintillator will be used merely to count the number of pulses so that the wireless uprange controller can shut down the Golden X-Ray Source at the end of each volley, and when the desired total pulse count is achieved.

Another form of scintillator crystals are small, rectangular bits (approximately 14 mm×14 mm) and will sit in front of the transmission point of the X-Ray sources. Other forms are possible, such as a flat, circular disk that is the same diameter as the emission point of the X-Ray sources so as not to cause any transmission irregularities in having a small square scintillator as opposed to one that is even is size and thickness and completely covers the transmission port of the X-Ray sources.

The wireless X-Ray uprange controller will have the ability to operate as a wired device as well as wireless. The wireless X-Ray uprange controller will use CAT5 cable initially for the wired version, although other wire types may be utilized for the production model. To use the wireless X-Ray uprange controller in the wired mode, all transmitting receptacles will be shut off, and all information will be transmitted to the uprange controller via a CAT5 cable.

The wireless mode will utilize Wi-Fi type transmitter initially, although the final production model may utilize 2.4 GHz or 900 MHz, and/or Infra-Red. A particularly useful form is to use the 900 mHz XBee transceiver module, which allows a tablet form of computer (iPad) to be used as the host of the controller system. The iPad basically becomes a “universal remote” for the X-Ray generator and other devices.

The uprange controller will feature a touch-screen interface. This touch screen interface will be either an Apple touch screen product such as the iTouch, iPad, or iPhone. The touch screen interface may also be an Android touch screen product such as an Android based tablet computer, or phone. The touch screen interface can also operate with other platforms as they are developed. The touch screen will utilize a proprietary application to utilize the various touch screen interfaces as controllers to create the “transmission commands” for the receiver to process and carry out.

The uprange controller will have three preset modes, and one user save-able mode. The three modes will be:
—“Default”—This mode will pre set the volley sizes and “rest times” between volleys to reflect the manufacturer's recommendations for using the golden X-Ray sources without damaging them. A volley is a specified number of pulses fired consecutively with no intended pauses in-between.
—“Extreme” mode will allow the user to bypass manufacturer's recommendations, acknowledging the possibility of damaging the X-Ray source. For, example, some machines require a cool down period after 99 pulses, but the operator may choose to forego the rest period.
—“Precaution” Mode (or some other similar wording)—This mode will allow the user to go above and beyond the manufacturer's safety recommendations, and will only allow 1 pulse per second.
—User Presets: This mode will allow users to save their preferred volley sizes, and rest periods between pulses/volleys.

The uprange controller will also feature an auditory and visual safety notification (such as a “3,2,1” countdown with flashing lights) when the system is going to begin pulsing, and the ability to stop the pulsing at any time while maintaining the overall pulses transmitted, and the pulses remaining on the transmission order. If the transmission order is interrupted at any time, the processor will also maintain the status of the transmission order so that the transmission can be continued once the problem has been rectified and the transmission is restarted. The software will also attempt to carry out a transmission order a minimum of 5 times before giving the operator an error message. If even a single X-Ray pulse is generated during those five attempts, the software will make an additional 5 attempts to carry out the transmission order until those 5 subsequent attempts have failed. Then the operator will receive the error message, and will be required to take physical action to rectify the issue.

A desirable feature of the disclosed system is a dosimeter which is placed behind the image plate. The dosimeter can be used to show a continual read out of the amount of energy that has passed through the target. It can also be used as a controller of the X-Ray generator, with the desired X-Ray energy to pass through the target being set and the dosimeter shutting off the X-Ray generator when that amount of energy has been sensed.

When working with technology for bomb technicians, calculations are often made concerning the safe distance from a target if it is deliberately blown up with explosives placed by the technician. What the technician does now is use a calculator, pen and pencil or a table to calculate safe distance from explosives being blown up. Part of the disclosed technology is the use of an application on the uprange controller which performs a calculation for blast and fragmentation safe distances. The technician would enter in the quantity of explosives in the explosives load, and the type of explosive. The application on the uprange controller would provide the calculation results which would include distances for gas over-pressure, and safe fragmentation distance. Another factor in these calculations is the type of casing which is around the explosive. If the explosive is an artillery shell, the thicker wall casing results in fragmentation traveling further. If the explosive is inside a paint can, the pieces of the casing are smaller and lighter, and would thus travel less distance. This information would be calculable on the uprange controller, and replace the manual method of these calculations.

The uprange controller also has the capability in performing precision aim calculations. These are calculations which convert the image on the image plate into real world distances and spacing. If the image plane census is not the exact size of the target itself. What happens is similar to what happens when a person stands near a wall, and a flashlight is shined at the person. A shadow is projected onto the wall behind the person. However, the shadow is larger than the person because the light spreads from a central point of light. The calculations performed in the precision aimed formula is like taking the oversized shadow and reducing it to the actual size of the target. When the exposure is started, small markers are placed on the target as reference points. These are called fiducials, and show up in the X-Ray image as dots. Once the image has been corrected to actual size, a technician can measure the exact locations of certain objects inside the target based on the position of fiducials which are near the suspect components of the target. For instance, the technician can read the image and say that a certain object is two inches to the right and one inch above fiducial number three. A technician can then set up a PAN (Percussion Actuated Neutralizer) on the same angle or as math azimuth of the X-Ray generator, and he will know that if a destructive charge is sent at exactly that spot, the suspect component of the target will be contacted.

The PAN is a barrel closed on one end, and filled with a projectile. The projectile may be a solid projectile like a piece of lead, or it may be a liquid projectile such as a column of water. An explosive charge at the rear of the PAN drives the projectile out the front end of the barrel and into and through the target, as if the PAN were a rifle. Even though the projectile may be water, its large mass conducts the energy of the explosive in a controlled path through the target. A shaped charge may also be used to accomplish the same thing. A shape charge is a piece of explosive shaped with a void and typically a liner of copper. The void causes and accentuation of the explosive charge, and the copper is melted and projected forward in a stream of molten metal. This stream of molten metal has the ability to penetrate dense material such as armor plating, by burning a hole in the armor plating and having a jet of molten copper shoot through the hole.

The uprange controller of the system, can serve as a universal remote for a number of different remotely controlled technologies, and can serve as a firing device for the PAN. The current technology of firing the PAN is to attach a section of shock tube to the PAN. The shock tube is filled with flammable or explosive material which burns at a carefully calculated rate. Therefore the length of the shock tube which is attached to the PAN can be used as a timer to set off the PAN at a specified time. When used as a remote firing controller for the PAN, a firing box is utilized. The firing box is attached to the backside of the PAN, by a selected length of shock tube. The firing box includes a housing, a wireless transceiver such as an XBee module, a high energy spark initiator, an antenna which may be internal or external, and a battery. The firing box may be sacrificed if the target explodes when the PAN is fired.

The system uprange controller can also include a control unit which operates with an image scanner. One type of scanner which has utilized this technology is a CR plate (Computed Radiography). The CR plate is covered by a phosphorous material which absorbs energy from the X-Ray pulses. Since the internal components of the target absorb some of the energy passing through it, what is recorded on the plate is an X-Ray image or picture of the internal components of the target, showing their density to X-Rays. To read the image on the CR plate, the CR plate is exposed to red light. When it is exposed to red light, the CR plate emits a blue light. The amount of blue light sensed over the surface of the CR plate is recorded which forms the X-Ray image.

One option in the current technology is to use a device an MMX scanner (Multi-mission X-Ray). In a scanner of the MMX type, the CR plate is incorporated into a scanning device. When the CR plate absorbs the X-Rays from the X-Ray exposure, a scanner passes over the CR plate, exposes it to red light, and reads the blue light which is emitted. This operates just like a digital scanner which scans a sheet of paper by passing a sensor from one side of the paper to another and recording the amount of light that is reflected from the paper. An MMX scanner scans the CR plate and records an image. It is then connected by a USB port to a computer in order to view the image. The downrange controller of the system is plugged into the MMX scanner by means of a USB port, and transmits the image to the uprange controller of the disclosed system. In this way the image can be immediately viewed, and the CR plate can be cleared and rescanned if necessary. The MMX scanner and a control unit of the system can also be combined with the use of a dosimeter behind the CR plate to operate as described above.

The uprange controller unit of the disclosed technology, in its role as universal remote for all X-Ray and bomb activities, can also serve as a control unit for the drone aircraft. One function of the drone aircraft is to fly over a battlefield and detect radio transmissions from enemy personnel. Typically an enemy spotter is in a forward position and transmits observation about friendly troop movements, types of vehicles, and personnel numbers and direction. An enemy coordinator perceives those transmissions and instructs the enemy forward spotter to move to other locations or to verify the information. These radio transmissions are detected and sensed by the drones, and by use of triangulation, the drones can pinpoint the location of enemy radio transmissions. This location data can be displaced on the touch screen of the user, with the uprange controller of the disclosed system acting as a universal controller for the drones. Instructions can be sent to the drones to move to other locations, to fly a scanning pattern in front of friendly positions or in front of a convoy or to fly to other areas where enemy transmissions are picked up. A person with the uprange controller of the disclosed technology can hand control of one or more drones to technicians in other areas for taking over control and operation of the drones.

In its role as universal controller, the uprange controller of the disclosed technology can receive information from sensors which are placed in the field around a target, or around a site where explosives have been placed. The sensors can be detectors of wind, temperature, and the presence of certain chemicals. The sensors can transmit their data to the uprange controller, and the technician can use that information to make decisions about blowing up the target with consideration for possible drift of hazardous material or chemicals.

### Hardware Add-ons

MMX Wireless Module —A module that will work with the MMX (Multi-Mission X-Ray) Digital X-Ray Scanner to transmit X-Ray images wirelessly from the MMX Scanner to the SMRT Box via memory modules that will store dual copies of the images until they can be transmitted wirelessly to the SMRT Box. The module will have its own power source, memory, processor to relay commands to the scanner, and transceiver to transmit and receive data wirelessly.

Dosimeter—A wireless module that will transmit X-Ray and Gamma dosage levels to the SMRT box. The module will utilize a battery, scintillator and processor to monitor the amounts of X-Ray and Gamma radiation that was received by the unit, and transmit that data via a wireless transceiver to the SMRT Box.

RFD (Remote Firing Device)—A wirelessly controlled high voltage initiator utilized to electrically initiate electric sensitive explosive components. The module will utilize a battery, wireless transceiver, a processor, and a spark-gap generator to generate the spark necessary to initiate a wide variety of electrically initiated explosives.

### BRIEF DESCRIPTION OF THE DRAWINGS

FIG. 1 is a diagram showing the general relationship of parts of the uprange controller system.

FIG. 2 is a diagram of the display on the uprange controller unit, showing the pulse setting, the pulse countdown, the ad button and the subtract button.

FIG. 4 is a view of the connection units on the up range controller.

FIG. 5 is a perspective view of the down range X-Ray controller.

FIG. 6 is a side view of the down range X-Ray controller.

FIG. 7 is the diagram of the remote firing device which is controlled by the up range controller in control of a drone airplane and receiving video signals and sending control signals to the drone

FIG. 9 is a view of the up range controller displaying video from drones and directing drones in triangulation operations for tracking the location of field radios and cell phones.

FIG. 10 is a view of the scintillation unit of the system.

### PREFERRED EMBODIMENTS

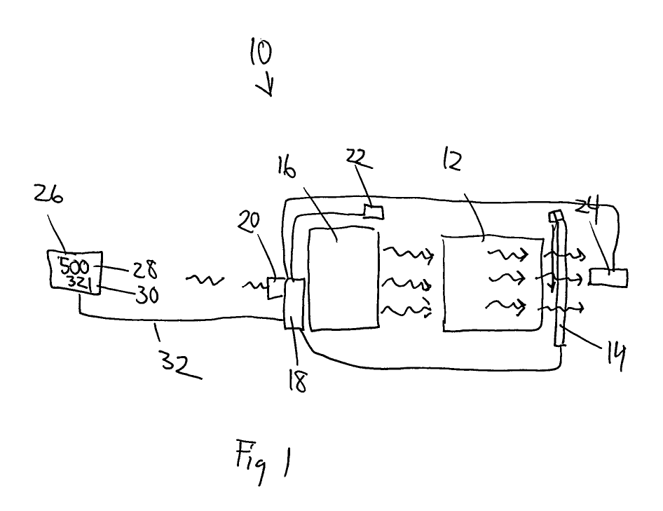

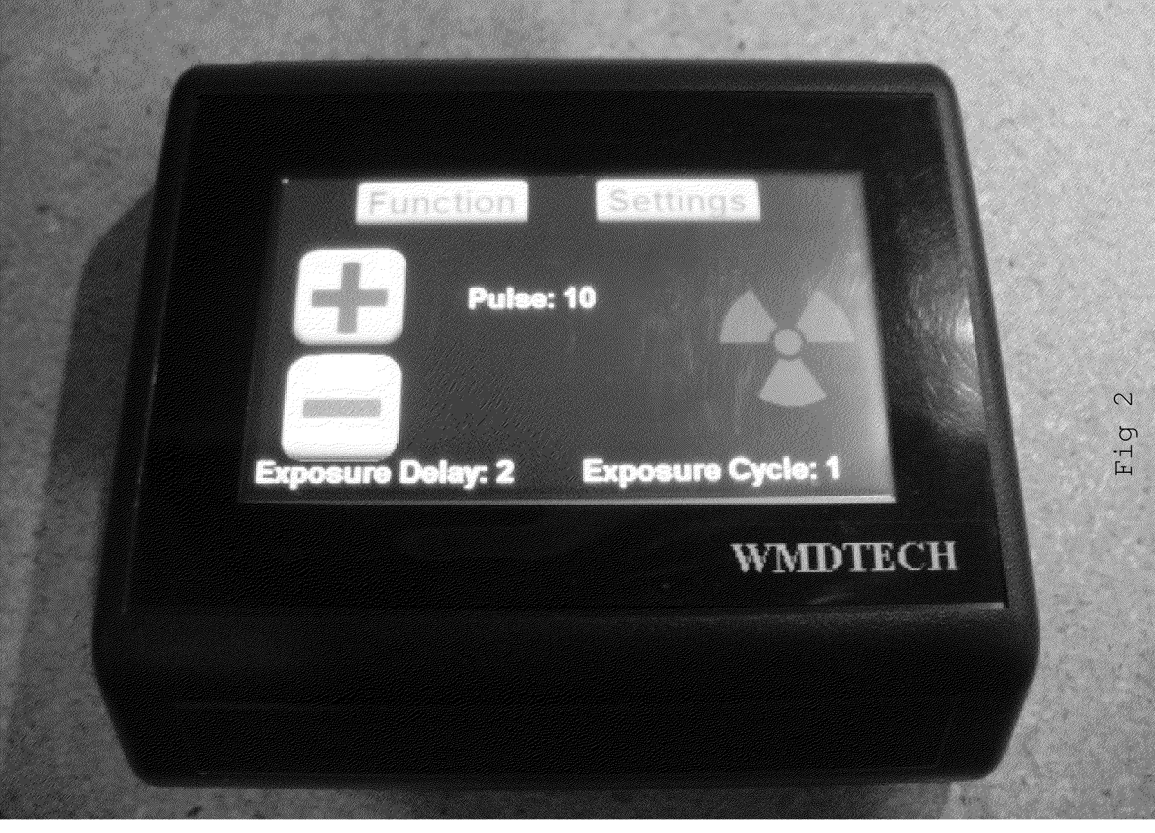

Several preferred embodiments of the disclosed technology are shown in the following figures. FIG. 1 shows the X-Ray uprange controller system 10, as it is shown in the field. Shown is a target 12 which may be an explosive device or a suspected explosive device. This could be a box, a suitcase, a duffle bag, a metal tube or any number of package shapes. On one side of the target 12 is an X-Ray plate 14. This can be in the form of a computed radiography (CR) plate. One type of plate allows the plate to be scanned on site by scanning the recorded X-Rays received by the plate. In a CR plate this allows an X-Ray image to developed and reviewed on site without the technician having to approach the target to retrieve the plate, and then possibly having to replace the plate for a second shot. When using a CR plate as an X-Ray plate, it can be connected electronically either wirelessly or by a wire with the down range controller of the system. The down range controller of the system is also attached to a scintillator 22 which measures the number of pulses that are generated by the generator 16. The down range controller is also attached to a dosimeter 24 which measures how much X-Ray energy has passed through the target and the X-Ray plate. It is possible for the target to contain enough dense materials such as led or concrete or steel that objects behind the shielding are not sufficiently eradiated to produce an image. The dosimeter is helpful in determining if sufficient X-Rays have passed through the shielding of the target. These can be read as the target is being eradiated and the unit can be programmed to continue the eradiation by multiple additional pulses until a certain amount of X-Rays have passed through the target to the dosimeter. Information from the controller is passed through a wireless transceiver 20 to the uprange controller. The uprange controller has a screen which shows the pulse settings 28 and a pulse countdown view 30. In this case the pulse settings have been set to deliver 500 pulses and the pulse countdown shows that 321 pulses remain to be delivered. There are huge advantages to using the uprange controller in a wireless fashion, but certain situations indicate use of a control wire 32 which is an option for the system.

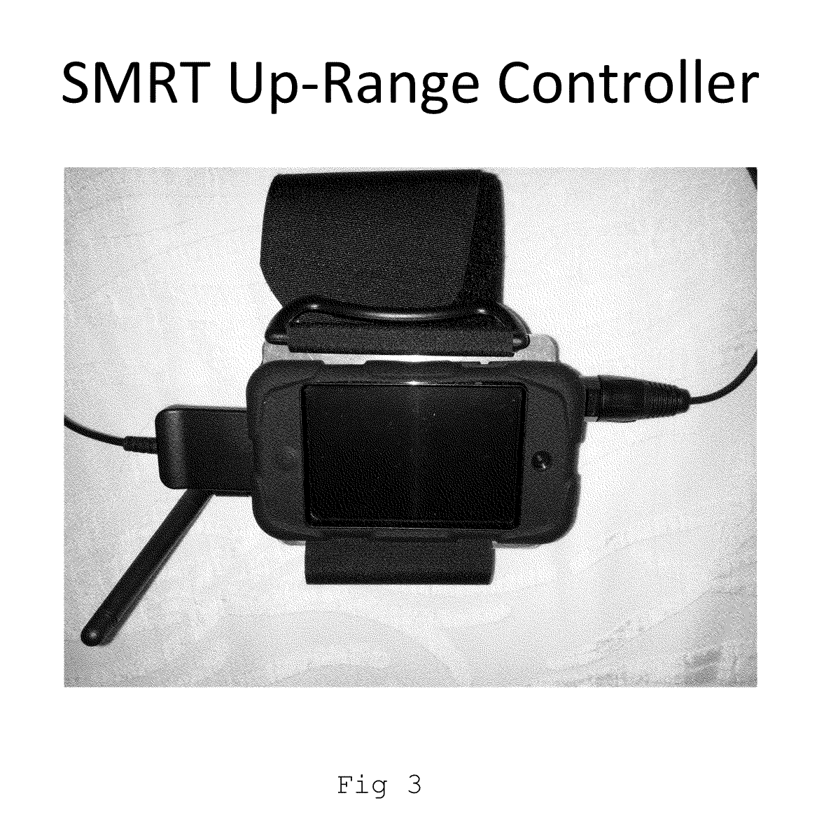

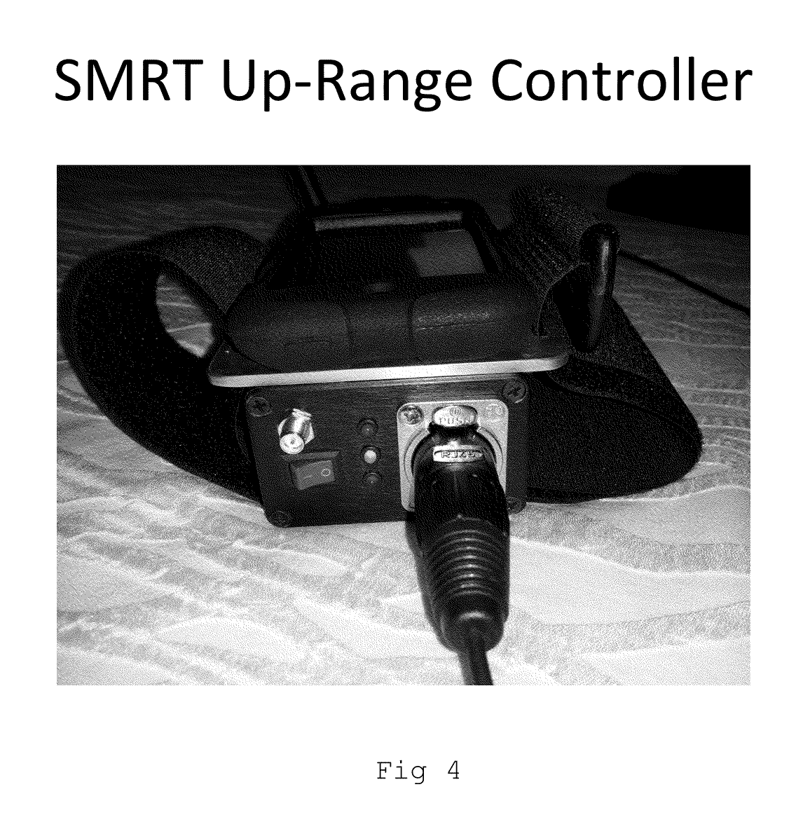

FIG. 2 is an example screen of the uprange controller unit 26 of the disclosed system. It includes a plus button, a minus button, a display setting 28 and a pulse countdown 30. Shown in FIG. 3 is one preferred embodiment of the uprange controller device of the disclosed system. This version of device is based on a cell phone platform, in this case an iPhone. Other electronic devices could be utilized and modified to function as the uprange controller device of this system. This conversion for use of the uprange controller device for the wireless parts of the system is based on modification of the phone with a XB Module. Attached to the phone, shown in FIG. 3 is an arm band which is worn by the operator and can be made long enough to fit around the arm of a bomb suit. The iPhone provides the capability of a touch screen, through which the control application can be controlled. FIG. 4 is an end view of the iPhone adapted for use as their controller, and shows the module attached to the iPhone which includes antenna connection, on and off switches, and a cat4 cable for wired operation of the system.

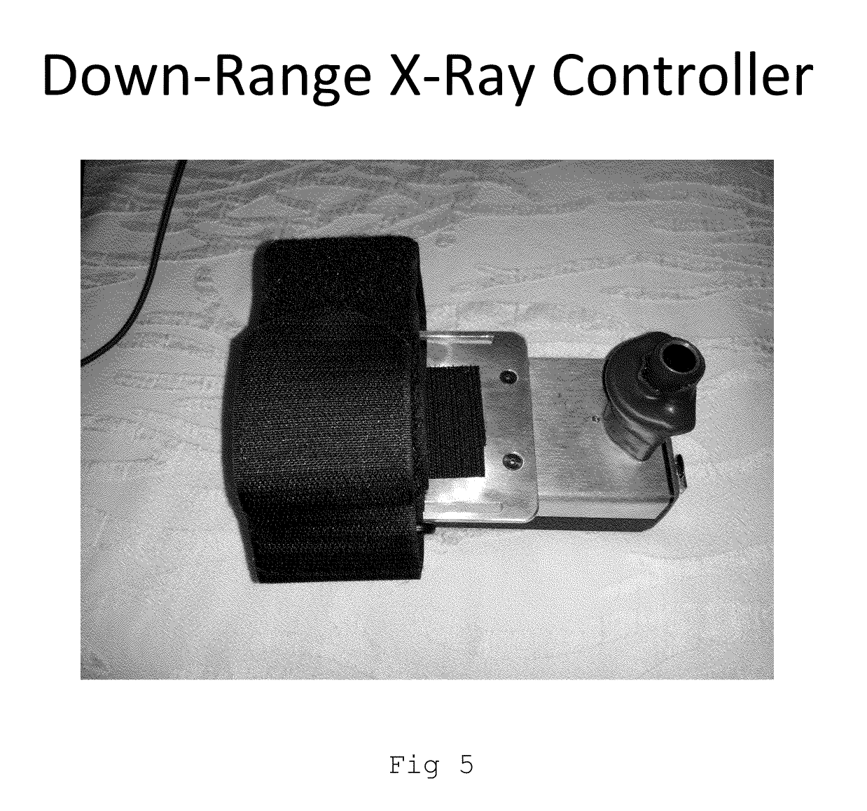

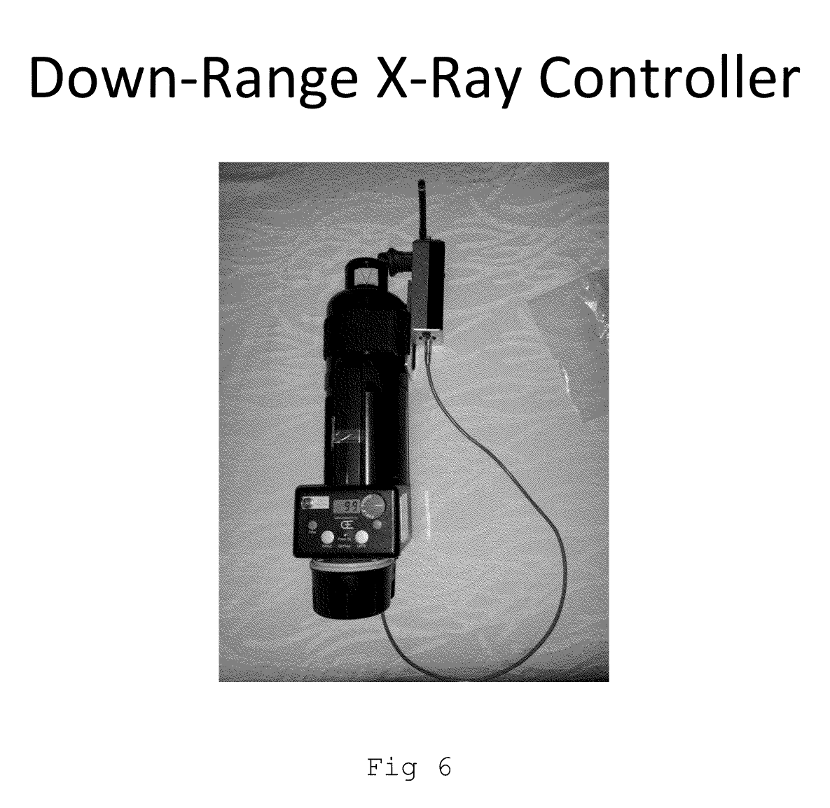

Shown in FIG. 5 is the down range X-Ray controller which would be connected to the X-Ray generator 16 and would coordinate the operation of the X-Ray generator, the scintillator, the dosimeter and possibly the CR plate 14. FIG. 6 is a side view of the X-Ray down range controller. Shown in FIG. 6 is the wireless transceiver 20.

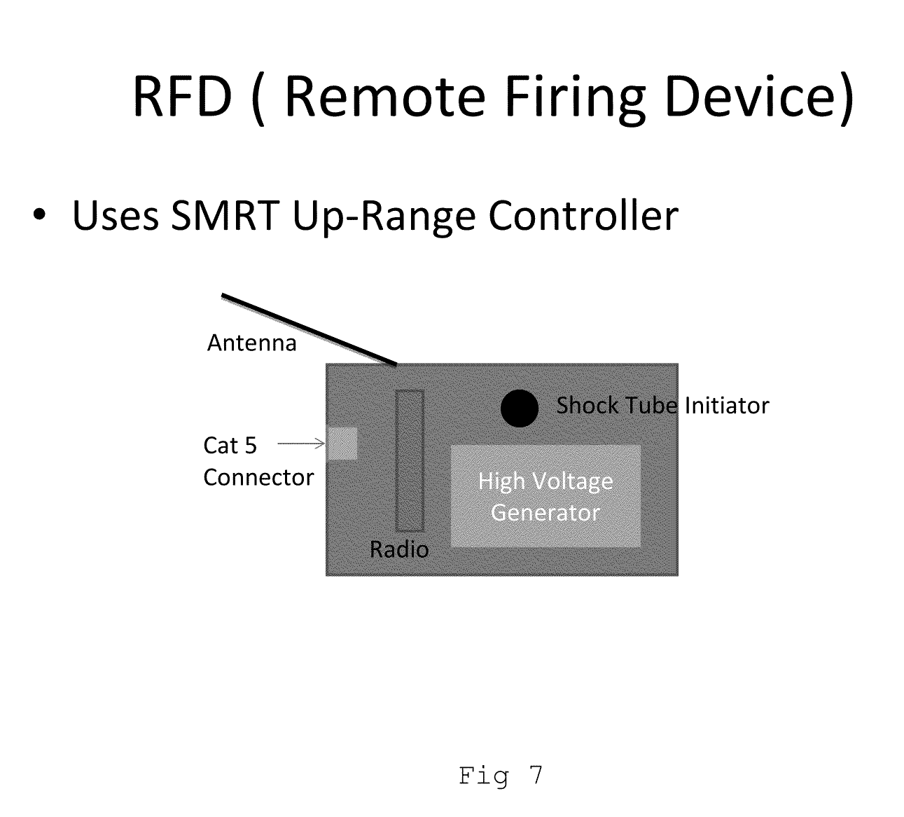

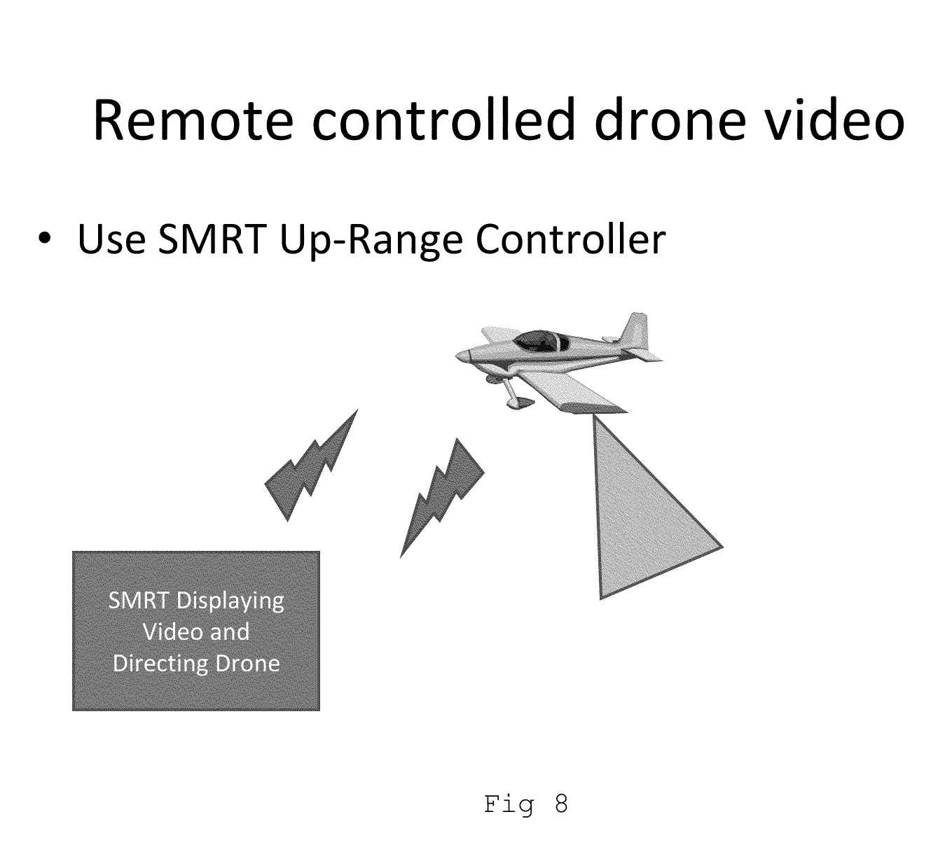

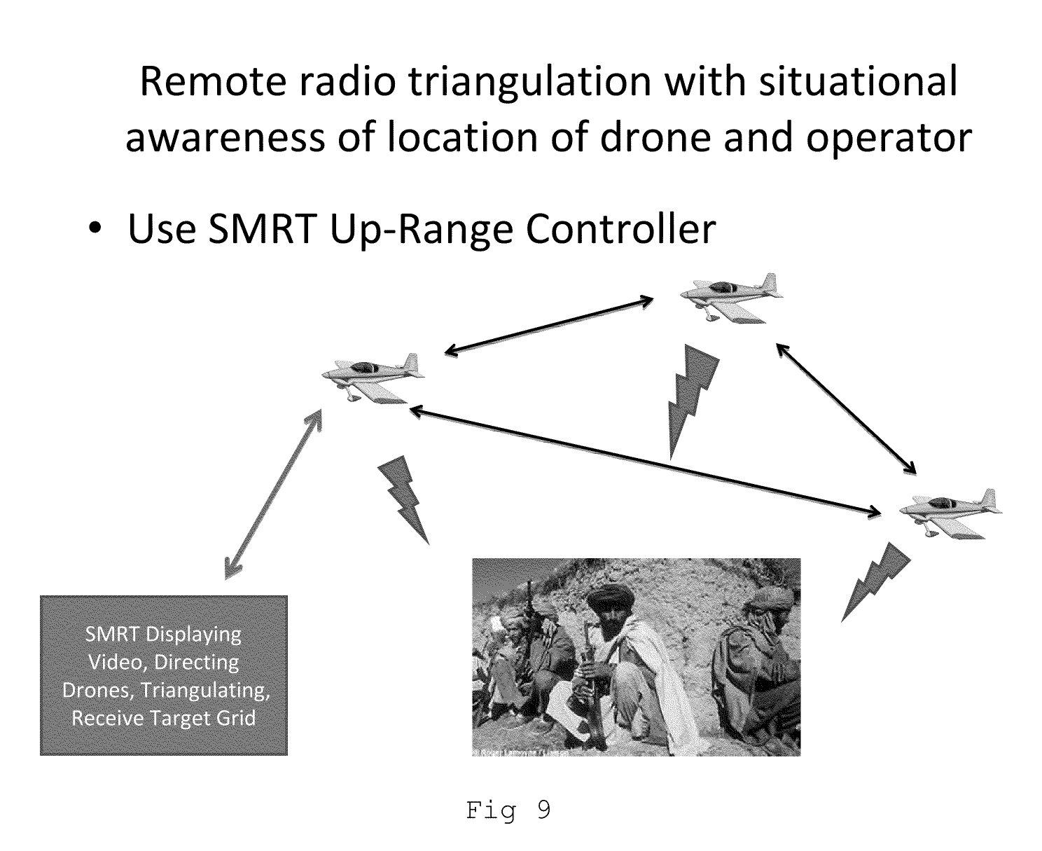

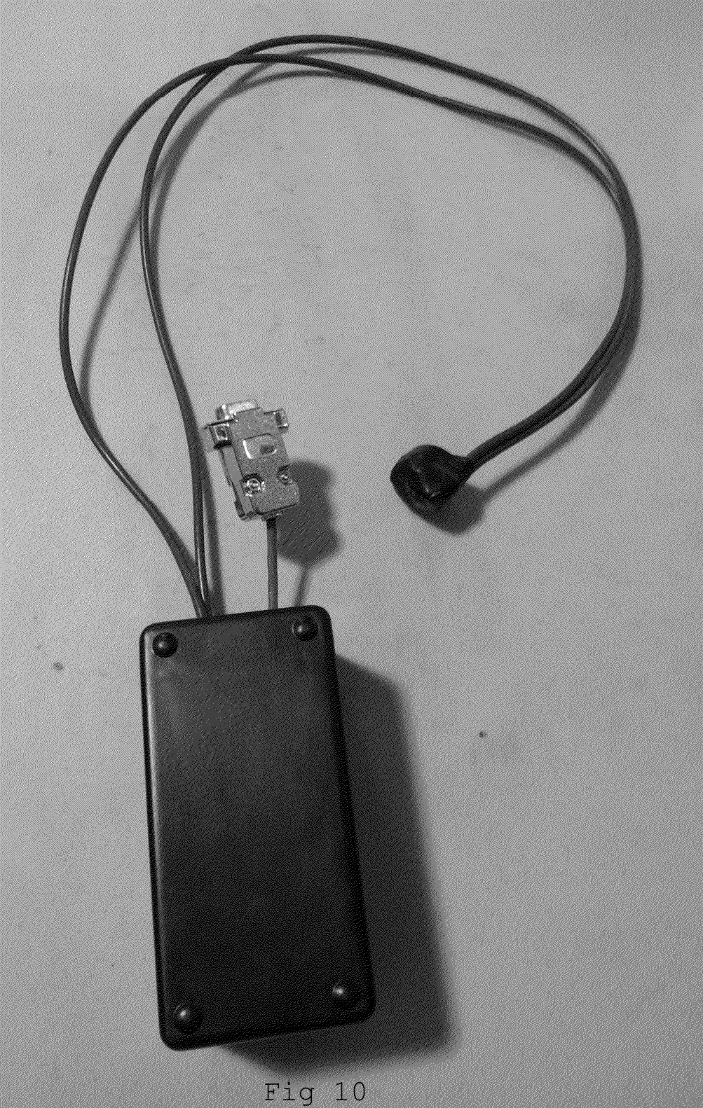

FIG. 7 is a diagram showing the remote firing device which can be utilized with the system including the uprange controller. The remote firing device receives input from the down range controller from a CAT5 connector, or from the uprange controller. It includes a high voltage generator and a shock tube initiator. When the remote firing device is used, a short section of shock tube is utilized to connect to the PAN. FIG. 7 is a diagram showing the control of drone aircraft by use of the uprange controller. This would be by the addition of an appropriate application. FIG. 8 shows the use of the drones for triangulation and for directing the drones, and FIG. 8 shows the use of the uprange controller for triangulation onto locations of enemy radio sources in the battlefield.

Shown in the figures is a close up of the prototype scintillator, which monitors the transmission of X-Ray energy, and feed it back to the receiver and processor. An overhead view of the prototype receiver and the attached scintillator. The prototype receiver has LED lights to notify when is it powered on, and when it is actively transmitting as well as when it is detecting X-Ray transmissions. Also shown is an overhead view of the protype controller with touch screen interface. This will allow the user to program in the total number of pulses, the numbers of pulses per “volley”, and any break time desired between “volleys”. Shown is a side view of the prototype controller. This demonstrates the CAT5 input connector, and various power configurations for charging the internal battery or running on external power.

I claim:

1. A portable X-Ray system for X-Raying a target which is a suspected hazardous or explosive device, comprising:
a portable pulsing type X-Ray source with selectable pulse number;
a down range controller with a wireless receiver/transmitter functionally connected to said X-Ray source, for receiving and sending signals from a controller;
an uprange wireless uprange controller unit with control settings for the total number of pulses to be generated by the X-Ray source, the pulses per cycle, and the duration of rest periods between cycles, and a readout of pulses that have been sent, and an activation button; and
an image plate configured for placement behind an X-Ray target, to record an X-Ray image of the target.

2. The portable X-Ray system of claim 1, in which said uprange uprange controller unit is in the form of a forearm mountable controller, configured for use on a bomb suit, and which utilizes glove accessible touch screen controls.

3. The portable X-Ray system of claim 1 which further comprises an X-Ray sensor placed adjacent to said X-Ray source, for detecting X-Ray and transmitting a current status of X-Ray to said uprange control unit through said downrange controller.

4. The portable X-Ray system of claim 1 which further comprises a dosimeter functionally connected to said downrange controller and placed on a side of said target opposite said X-Ray source, for detecting X-Ray quantities that pass through said target from said X-Ray source.

5. The portable X-Ray system of claim 1 in which said controllers is configured to send RF frequency signals at a selected frequency for communication.

6. A portable X-Ray system for X-Raying a target which is a suspected hazardous or explosive device, comprising:
a portable pulsing type X-Ray source with selectable pulse number;
a down range controller with a wireless receiver/transmitter functionally connected to said X-Ray source, for receiving and sending signals from a controller;
an uprange wireless uprange controller unit in the form of a forearm mountable controller, configured for use on a bomb suit, and which utilizes glove accessible touch screen controls, with control settings for the total number of pulses to be generated by the X-Ray source, the pulses per cycle, and the duration of rest periods between cycles, and a readout of pulses that have been sent, and an activation button;
an X-Ray sensor placed adjacent to said X-Ray source, for detecting X-Ray and transmitting a current status of X-Ray to said uprange control unit through said downrange controller; and
an image plate configured for placement behind an X-Ray target, to record an X-Ray image of the target.

7. The portable X-Ray system of claim 6 which further comprises a dosimeter functionally connected to said downrange controller and placed on a side of said target opposite said X-Ray source, for detecting X-Ray quantities that pass through said target from said X-Ray source.

8. The portable X-Ray system of claim 1 which further comprises of one or more repeaters, to extend the operating range of said controller from said receiver/transmitter.

9. The portable X-Ray system of claim 1 in which said uprange controller comprises a first screen number touch screen interface to control the number of pulses to be generated, as well as links to settings screens to access presets, and other applications.

10. The portable X-Ray system of claim 1 in which said uprange controller comprises a cell phone modied by addition of a line of sight RF transceiver.

11. The portable X-Ray system of claim 1 in which said controller further comprises a second screen with a keypad touch interface to change pulse and time quantities, and indicators for the number of pulses selected, the pulses per cycle, and the duration of rest periods between cycles.

12. A portable X-Ray system for X-Raying a target which is a suspected explosive device, comprising:
a portable pulsing type X-Ray source with selectable pulse number;
a downrange controller with a wireless receiver/transmitter functionally connected to said X-Ray source, for receiving signals from an uprange controller;
an uprange wireless uprange controller unit with control settings for the total number of pulses to be generated by the X-Ray source, the pulses per cycle, and the duration of rest periods between cycles, a readout of pulses that have been sent, and an activation button;
a radiation sensor proximate to said X-Ray source, for sensing radiation and sending a signal to said uprange wireless uprange controller unit; and
an image plate configured for placement behind an X-Ray target, to record an X-Ray image of the target.

13. The portable X-Ray system of claim 12 in which said radiation sensor is an X-Ray scintillator configured to convert sensed radiation into an electronic signal proportionate with the amount of radiation sensed.
